(19) United States
(12) Patent Application Publication
(10) Pub. No.: US 2015/0161842 A1
(43) Pub. Date: Jun. 11, 2015

(54) PROTECTIVE FOOT COVERINGS AND VENDING SYSTEM THEREOF

(71) Applicant: Janice Burr, Willits, CA (US)

(72) Inventor: Janice Burr, Willits, CA (US)

(21) Appl. No.: 14/531,219

(22) Filed: Nov. 3, 2014

Related U.S. Application Data
(60) Provisional application No. 61/898,590, filed on Nov. 1, 2013.

(51) Int. Cl. G07F 11/38; A43B 17/00

(52) U.S. Cl. CPC G07F 11/38; A43B 17/00

(57) ABSTRACT

A vending system for providing foot covering comprising: a housing for holding and displaying protective foot coverings; a payment receiver; a product retrieval area; and a plurality of selection buttons. The protective foot covering may include an ankle-encircling band and a main body. Further, the plurality of selection buttons may provide a means to select a type of protective foot covering where said selection type is based on size and the gender. Preferably, the vending system is placed in a public access area such as an airport, hospital, bowling alley, clinic and pool.

### CROSS REFERENCE TO OTHER APPLICATIONS This application claims priority to U.S. Provisional Application Ser. No. 61/898,590 filed on Nov. 1, 2013.

### BACKGROUND OF THE INVENTION

1. Field of the Invention

The present invention relates to protective foot coverings and a vending machine that dispenses the protective foot coverings.

2. Description of Related Art

As an airport security regulation, passengers are asked to remove their shoes during mandatory security checks that take place before boarding. Typically, the procedure consists of removing and placing shoes on plastic containers that are screened alongside other luggage; meanwhile however, passengers must resort to walking barefoot through the remaining security points until they are able to retrieve their shoes. Travellers must therefore walk barefoot on unsanitary floors that may be infested with mold, fungus, and bacteria carried by other passengers and airport security officers. This is problematic for passengers because of the exposure and possible contamination that they face when walking through said airport floors.

Therefore, it would be desirable in the art to provide passengers with a protective foot covering that they can place over their bare feet or socks while complying with airport security regulations. It would also be desirable in the art for the protective foot coverings to be made available to passengers at airports by means of a vending machine that dispenses said protective foot coverings.

### SUMMARY OF THE INVENTION

The present invention relates to a vending system for providing foot covering comprising: a housing for holding and displaying protective foot coverings; a payment receiver; a product retrieval area; and a plurality of selection buttons. The protective foot covering may include an ankle-encircling band and a main body. Further, the plurality of selection buttons may provide a means to select a type of protective foot covering where said selection type is based on size and the gender. Preferably, the vending system is placed in a public access area such as an airport, hospital, bowling alley, clinic and pool.

### BRIEF DESCRIPTION OF THE DRAWINGS

The advantages and features of the present invention will become better understood with reference to the following detailed description and claims taken in conjunction with the accompanying drawing and in which:

FIG. 1 depicts a perspective view of a pair of protective foot coverings in accordance with an exemplary embodiment of the present invention.

FIG. 2 depicts a perspective view of a protective foot covering vending machine in accordance with an exemplary embodiment of the present invention.

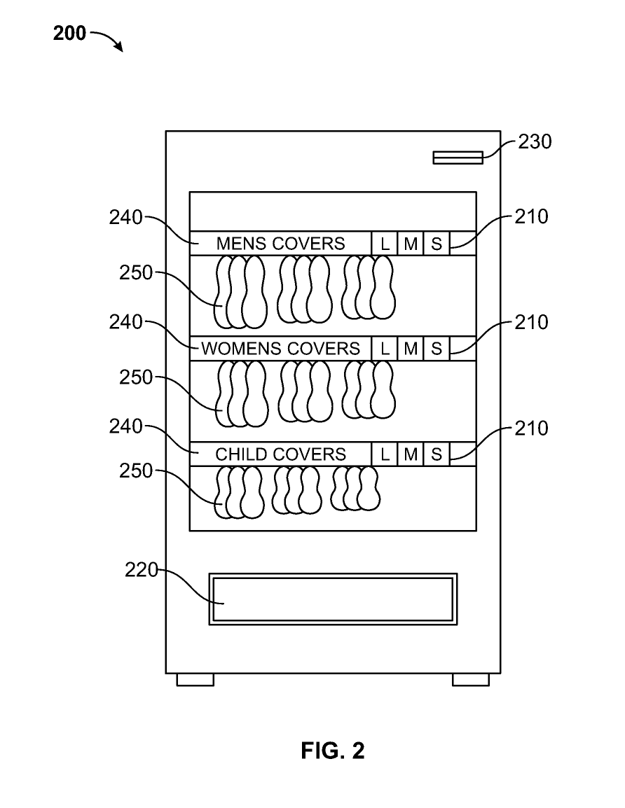

### DETAILED DESCRIPTION OF THE DRAWINGS

The present invention relates to a protective foot covering to be worn over a user's foot when the user finds it necessary to cover their feet e.g., in an airport where security regulations deem it necessary to remove your shoes and remain barefoot. The protective foot covering comprises an ankle encircling band and a main body to cover the user's foot. The present invention further relates to a vending machine that dispenses said protective foot coverings. With the protective foot coverings and vending machine that dispenses same, airline passengers are provided with a way to prevent exposure and contamination of mold, fungus, and bacteria found on airport floors.

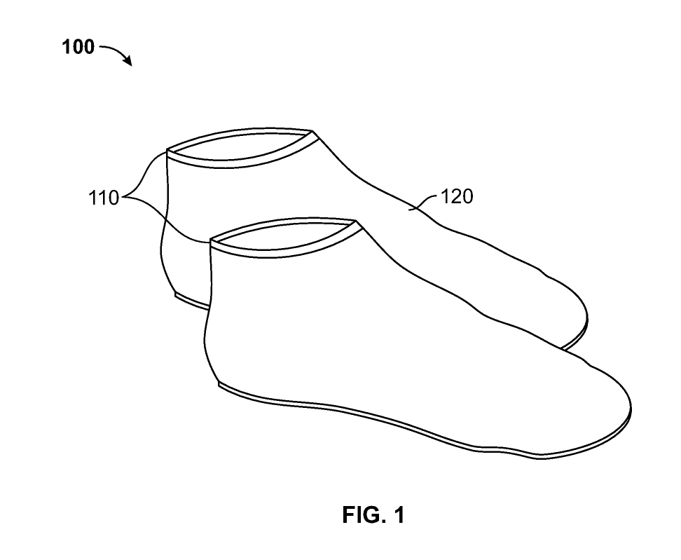

Turning now descriptively to the drawings, referring to FIG. 1, a perspective view of a pair of protective foot coverings 100 in accordance with an exemplary embodiment of the present invention. The protective foot covering 100 comprises an ankle-encircling band 110 and a main body 120. The ankle-encircling band 100 is made of an elastic band, but may be made with any suitable material. The ankle-encircling band 100 provides an elastic band to ensure that the protective foot covering 100 remains secured on the user's foot while in use. The ankle-encircling band is directly adjacent and fixed to the main body 120. The main body 120 can be made of a paper, plastic, or cloth material, but may be made of any other suitable material. The main body 120 provides a protective barrier between an unsanitary floor surface and the user's bare feet. The protective foot coverings 100 have many advantages, including providing a protection against mold, fungus, and bacteria found on floors.

Turning now descriptively to the drawing, referring to FIG. 1, a perspective view of a protective foot cover vending machine 200 in accordance with an exemplary embodiment of the present invention. The vending machine 200 comprises a payment receiver 230, selection buttons 210, product holding and displaying shelves 240 for the protective foot coverings 250, and a product retrieval area 220. The payment receiver 230 will accept different kinds of payment, i.e. cash and credit cards. Furthermore, the vending machine 220 will also accept codes as payment, which are to be furnished by airlines to its passengers for retrieving the protective foot coverings 250. The selection buttons 210 provide a way to select what type of protective foot covering the user may want, such as, the size and the gender. The vending machines 220 may be located in publicly accessible areas of airports to provide passengers with readily available access to the protective foot coverings 250. The vending machines 220 may also be placed in other publicly accessible areas where there may be a need for readily available protective foot coverings 250 such as in hospitals, bowling alleys, clinics, and pools. The protective foot covering vending machines 200 have many advantages, including providing the public with convenient access to protective foot coverings 250.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A vending system for providing foot covering comprising:
a. a housing for holding and displaying protective foot coverings;
b. a payment receiver;
c. a product retrieval area; and
d. a plurality of selection buttons.

2. The vending system according to claim 1, where the protective foot covering includes an ankle-encircling band and a main body.

3. The vending system according to claim 1, where the plurality of selection buttons provide a means to select a type of protective foot covering where said selection type is based on size and the gender.

4. The vending system according to claim 1, where the vending system is placed in a public access area.

5. The vending system according to claim 4, where the public access area includes at least one of airport, hospital, bowling alley, clinic and pool.
